(19) United States
(12) Patent Application Publication
(10) Pub. No.: US 2020/0078907 A1
(43) Pub. Date: Mar. 12, 2020

(54) DISMANTLING TOOL

(71) Applicant: Jih-Cheng YEH, Taichung City (TW)

(72) Inventor: Shang-Yuan HUANG, Taichung City (TW)

(21) Appl. No.: 16/126,743

(22) Filed: Sep. 10, 2018

(51) Int. Cl. B25B 5/10; B25B 27/00

(52) U.S. Cl. CPC B25B 5/101; F16B 2/065; B25B 27/0035

(57) ABSTRACT

A dismantling tool comprises a main body, a pushing mechanism, and an insertion hole. The pushing mechanism includes a driving portion and a pushing portion. The driving portion is located at the main body. The pushing element is movably screwed with the driving portion. The insertion hole is formed on the main body for a handtool to insert therein for engagement.

### BACKGROUND OF THE INVENTION

### Field of the Invention

The present invention relates to a dismantling tool, more especially to a dismantling tool used on suspension system.

### Description of the Prior Art

To reduce the uncomfort of passengers when driving through bumpiness, the suspension system of vehicle is used to absorb bounce and shock in order to stabilize the vehicle. Springs used in the suspension system for absorbing shock includes leaf springs, coil springs, torsion-bar springs, air springs, and other springs.

Specifically, the torsion-bar spring is often used in truck or SUV because it has a simple structure, smaller volume, and better durability. The torsion bar can cooperate with the torsion arm and the torsion adjusting assembly to adjust the predetermined load and height of vehicle. The torsion bar bears larger torque and easily gets rusty. To prevent from danger caused by damaged torsion arm, the torsion arm should be examined and replaced periodically.

Conventional dismantling tool for replacing the torsion arm is simply hooked on the support rack of vehicle to serve as a pushing element to push the seat of the torsion arm. However, the dismantling tool easily falls, and the pushing element is difficult to push the torsion arm well. Thus, much time is consumed during process of replacement, and the operation is not smooth.

### SUMMARY OF THE INVENTION

The main object of the present invention is to provide a dismantling tool. The main body abuts against the support rack via the seat portion so that the pushing element can push the torsion arm to rotate. A handtool is engaged with the main body by inserting into the insertion hole. During rotation of the pushing element, the user can exert an opposite force by the handtool to help the main body resist the torque. Thereby, the main body can be firmly positioned on the support rack.

To achieve the above and other objects, a dismantling tool of the present invention is provided. The dismantling tool is adapted for being used on a suspension mechanism. The suspension mechanism includes a support rack, a torsion bar, a torsion arm, and a torsion adjusting assembly. A first end of the torsion bar is adapted for connecting to an axle control arm mechanism, and a second end of the torsion bar is adapted for extending through the support rack and is positioned on the support rack. The torsion adjusting assembly is detachably positioned on the support rack. A third end of the torsion arm is detachably connected to the second end of the torsion bar to be corotating with the torsion bar, and a fourth end of the torsion arm abuts against the torsion adjusting assembly. The dismantling tool comprises a main body, a pushing mechanism, and an insertion hole.

The main body includes a seat portion, a body portion, and a head portion. The seat portion and the head portion are horizontally connected to a same side of the body portion to straddle on the support rack. The seat portion is adapted for abutting against and is positioned on the support rack.

The pushing mechanism includes a driving portion and a pushing element. The driving portion is connected to the head portion. The pushing element is movably screwed with the driving portion. The pushing element is adapted for being driven by a driving tool to push the fourth end of the torsion arm to rotate away from the torsion adjusting assembly.

The insertion hole is formed on the head portion. The insertion hole is adapted for a handtool to insert in and engage with to make the main body and the handtool have a corotation relationship.

When the driving tool rotates along a first direction to make the main body bear a force to have a first torque, the handtool exerts a force opposite to the first direction so that the main body has a second torque along a direction opposite to the first direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a first embodiment of the present invention;

FIG. 2 is a breakdown drawing of FIG. 1;

FIG. 3 is a top view of a main body of FIG. 2;

FIG. 4 is a front view of a main body of FIG. 2;

FIG. 5 is a stereogram of the present invention during operation;

FIG. 6 is a lateral view of the present invention during operation;

FIG. 7 is an illustration of the present invention during operation;

FIG. 8 is a stereogram of a main body of FIG. 2 at an other angle.

### DETAILED DESCRIPTION OF THE PREFERRED EMBODIMENTS

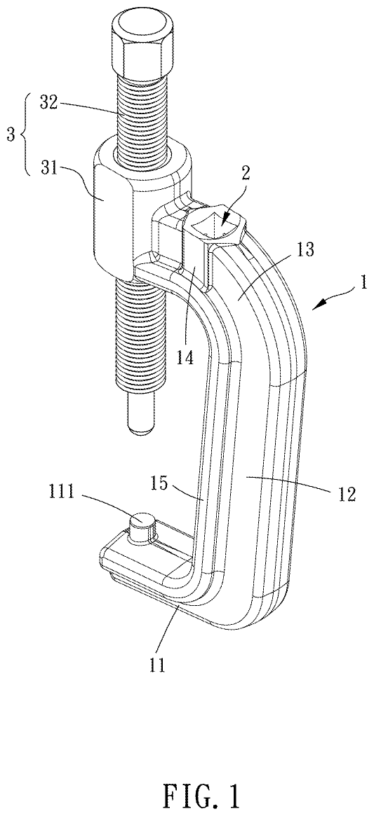

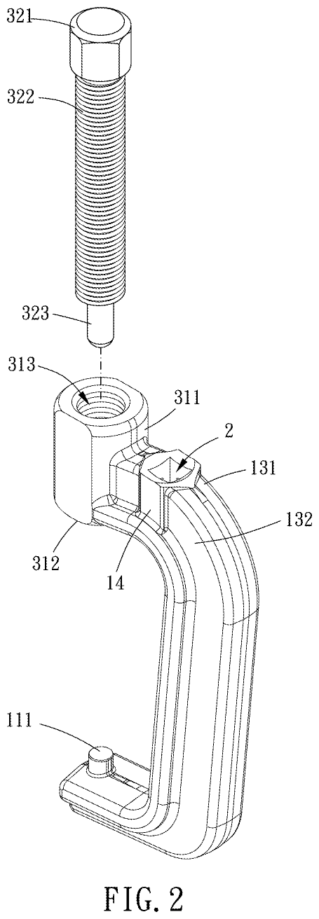

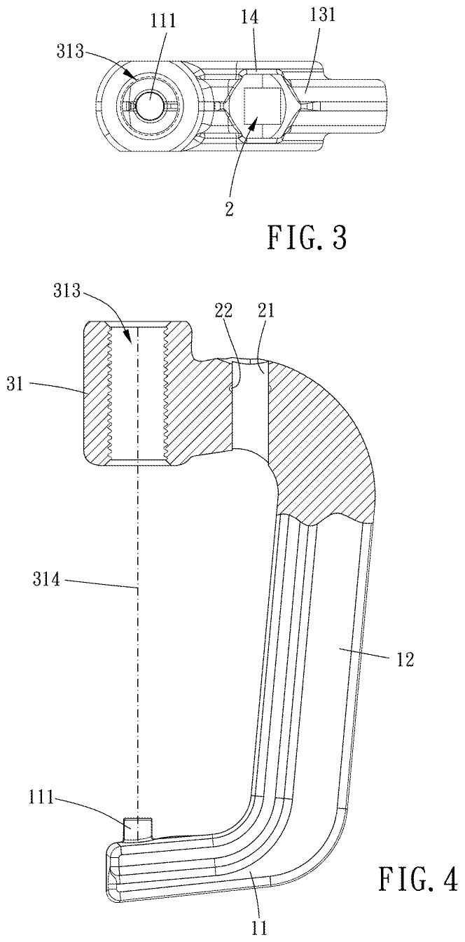

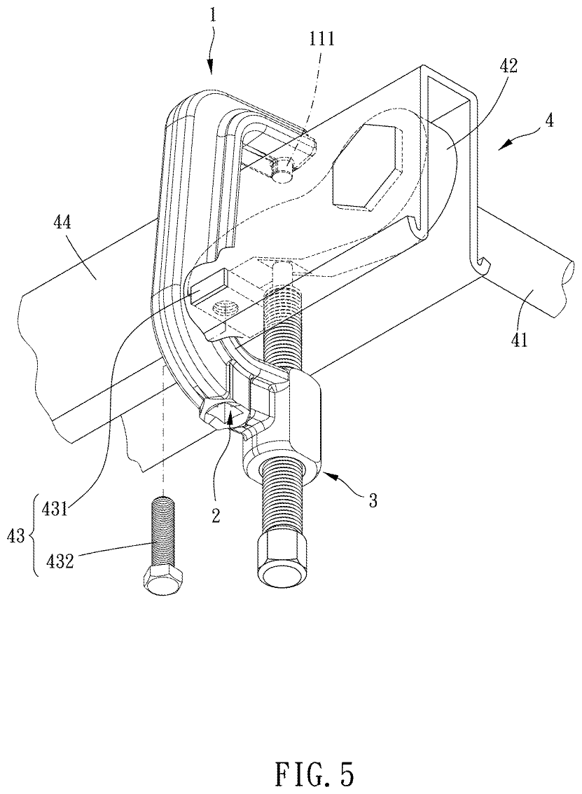

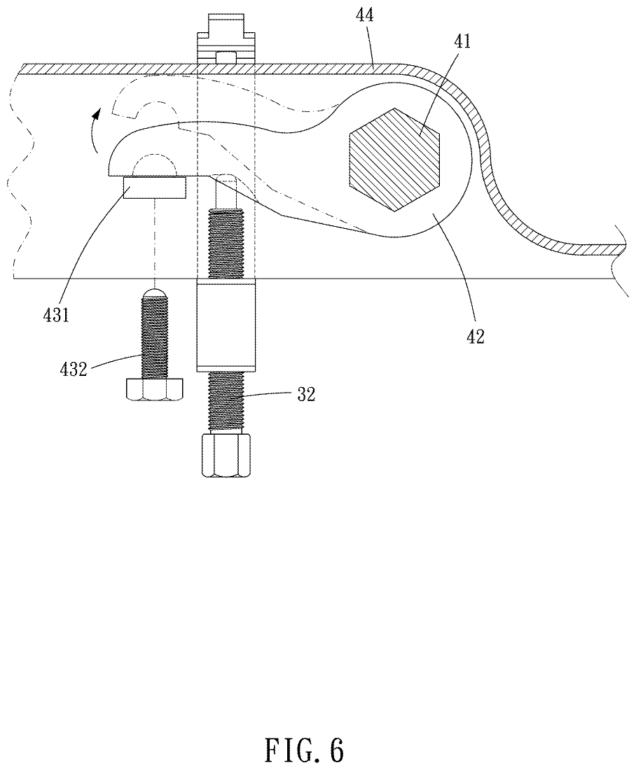

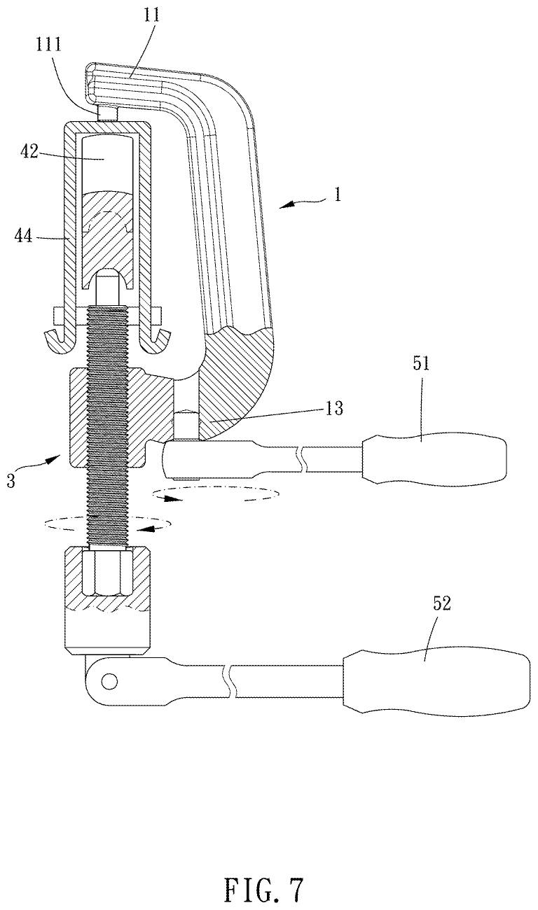

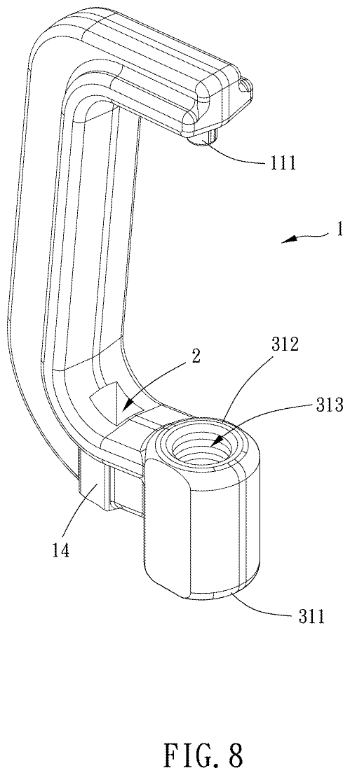

Please refer to FIG. 1 to FIG. 8, the dismantling tool of the present invention is adapted for being used on a suspension mechanism 4. The suspension mechanism 4 includes a support rack 44, a torsion bar 41, a torsion arm 42, and a torsion adjusting assembly 43. A first end of the torsion bar 41 is adapted for connecting to an axle control arm mechanism, and a second end of the torsion bar 41 is adapted for extending through the support rack 44 and is positioned on the support rack 44. The torsion adjusting assembly 43 is detachably positioned on the support rack 44. A third end of the torsion arm 42 is detachably connected to the second end of the torsion bar 41 to be corotating with the torsion bar 41, and a fourth end of the torsion arm 42 abuts against the torsion adjusting assembly 43. Specifically, the torsion adjusting assembly 43 includes a support seat 431 and an adjusting bolt 432. The support seat 431 is detachably disposed on the support rack 43 through the support rack 43. The adjusting bolt 432 is movably screwed with the support seat 431 to abut against the fourth end of the torsion arm 42 to adjust the pre-determined torque.

Thereby, the torsion bar 41, the torsion arm 42, and the torsion adjusting assembly 43 are linked-up to be positioned on the support rack 44. To replace the abraded torsion arm 42, the torsion arm has to be detached by the following steps. The adjusting bolt 432 is rotated to be removed from the support seat 431 so that the fourth end of the torsion arm 42 abuts against the support seat 431. And then, the dismantling tool is used to abut against the fourth end of the torsion arm 42 to make it rotate reversely to leave the support seat 431. When the support seat 431 is not pressed by the fourth end of the torsion arm 42, the support seat 431 can be easily removed from the support rack 44. Thereafter, the dismantling tool is removed, and the torsion arm 42 can be removed from the torsion bar 41 for replacement.

The dismantling tool includes a main body 1, a pushing mechanism 3, and an insertion hole 2. The main body 1 includes a seat portion 11, a body portion 12, and a head portion 13. The seat portion 11 and the head portion 13 are horizontally connected to a same side of the body portion 12 to straddle on the support rack 44. The seat portion 11 is adapted for abutting against and is positioned on the support rack 44. The pushing mechanism 3 includes a driving portion 31 and a pushing element 32. The driving portion 31 is connected to the head portion 13. The pushing element 32 is movably screwed with the driving portion 31. The pushing element 32 is adapted for being driven by a driving tool 52 to push the fourth end of the torsion arm 42 to rotate away from the torsion adjusting assembly 43.

In the present embodiment, the main body 1 is substantially U-shaped. The insertion hole 2 is formed on the head portion 13. The insertion hole 2 is adapted for a handtool 51 to insert therein for engagement so that the main body 1 and the handtool 51 have a corotating relationship. When the driving tool 52 is rotated along a first direction to make the main body 1 bear a force to have a first torque, the handtool 51 exerts a force reverse from the first direction so that the main body 1 have a second torque along a direction reverse to the first torque.

More specifically, when the driving tool 52 drives the pushing element 32 to push the torsion arm 42, the first torque makes the main body 1 move and deflect with respect to the support rack 44 to obstruct the operation. Thus, when the pushing element 32 rotates, the handtool 51 inserted in the insertion hole 2 is preferably rotated reversely to provide a second torque to overcome the first torque. Thereby, the main body 1 can be firmly positioned on the support rack 44 during the process of replacement to increase the efficiency and safety. In addition, the arm of force of the second torque is extended by the handtool 51 engaging with the main body 1 so that the user can provide the second torque easily.

The space below the vehicle is narrow, so useless protrusion needs to be reduced on the main body 1. Thus, the recessed insertion hole 2 for the handtool 51 to engage can reduce the volume of the main body 1. Besides, the handtool 51 can be quickly connected to or removed from the main body 1. Furthermore, the space for operation is reduced.

Preferably, the insertion hole 2 is formed with at least one positioning hole 22 on an inner wall thereof. The at least one positioning hole 22 is adapted for a positioning element of the handtool 51 to engage to enhance the engagement between the insertion hole 2 and the handtool 51. More preferably, when observing along a direction facing an opening of the insertion hole 2, at least one of two lateral faces 132 of the head portion 13 has a protrusion 14 adjacent to the insertion hole 2. The protrusion 14 is protruded along a radial direction of the insertion hole 2. The protrusion 14 can make the circumferential wall of the insertion hole 2 thicker to enhance the structure strength so that the head portion 13 is hard enough to bear the force from the handtool 51.

Specifically, the insertion hole 2 has a polygonal cross-section. In the present embodiment, the insertion hole 2 is a square hole. In other possible embodiments, the insertion hole can have a hexagonal cross-section. In addition, the insertion hole 2 of the present embodiment penetrates the head portion 13. Each of the two lateral faces 132 is formed with one said protrusion 14, and the two protrusions 14 are arranged symmetrically. Each of the protrusions 14 is rectangle plate-shaped. The head portion 13 has a hexagonal protruding portion. The insertion hole 2 is formed on the hexagonal protruding portion. The hexagonal protruding portion connects to the two protrusions 14.

The dismantling tool further includes two wing portions 15. Each of the wing portions 15 is substantially U-shaped. When observing along the direction facing the opening of the insertion hole 2, the two wing portions 15 extend symmetrically and laterally from two sides of the main body 1 so that the main body 1 has a T-shaped cross-section. Thus, the main body is similar to I-beam to be excellent to resist shear force and bending. More specifically, the driving portion 31 is formed with a threaded hole 313 having a larger diameter than the diameter of the insertion hole 2. An axis of the threaded hole 313 is parallel to an axis of the insertion hole 2. A ratio of a distance between the axis of the threaded hole 313 and the axis of the insertion hole 2 to a distance between the two lateral faces 132 is ranged 1.5 to 2.5.

More specifically, the pushing element 32 includes an engaging portion 321, a threaded section 322, and a pushing portion 323. The engaging portion 321 is adapted for the driving tool 52 to engage. The threaded section 322 is located between the engaging portion 321 and the pushing portion 323. An end of the pushing portion 323 remote from the engaging portion 321 is tapered and pokes toward the seat portion 11.

More specifically, the seat portion 11 is protrudedly formed with an abutting portion 111 for abutting against the support rack 44. The abutting portion 111 and the threaded hole 313 are co-axially arranged. Thereby, the force of the pushing element 32 and the force that the abutting portion 111 abuts against the support rack 44 are at the same line so that the main body 1 may not incline or shift during the pushing element 32 pushing the torsion arm 42.

If the axis of the threaded hole 313 is defined as a standard line 314, a highest portion of the driving portion 31 is located at a highest portion of the seat portion 11. In addition, the body portion 12 extends from the head portion 13 toward the seat portion 11 to approach the standard line 314. Thus, the center of gravity of the main body 1 approaches the head portion 13. Thereby, the main body 1 is stable when hooking on the support rack 44.

The head portion 13 further includes a working face 131 opposite to the seat portion 11. The working face 131 horizontally connects the two lateral faces 132. The insertion hole 2 is formed on the working face 131. The driving portion 31 includes a first end portion 311 and a second end portion 312. The second end portion 312 is located between the first end portion 311 and the seat portion 11. The first end portion 311 is protruded above the working face 131. Specifically, only the first end portion 311 is protruded above the working face 131 at an extension plane of the working face 131. Thus, the main body may not collide with objects around easily so that sufficient space around the driving portion 31 is ensured for the handtool 51 to operate.

In conclusion, when the main body is hooked on the support rack and the pushing element is rotated to push the torsion arm, a reverse torque can be provided by engaging the handtool to the main body. Thus, the main body is able to resist the torque of rotating the pushing element. As a result, the main body is stable positioned on the support rack during operation.

What is claimed is:

1. A dismantling tool, adapted for being used on a suspension mechanism, the suspension mechanism including a support rack, a torsion bar, a torsion arm, and a torsion adjusting assembly, a first end of the torsion bar being adapted for connecting to an axle control arm mechanism, a second end of the torsion bar being adapted for extending through the support rack and being positioned on the support rack, the torsion adjusting assembly being detachably positioned on the support rack, a third end of the torsion arm being detachably connected to the second end of the torsion bar to be corotating with the torsion bar, a fourth end of the torsion arm abutting against the torsion adjusting assembly, the dismantling tool comprising:
a main body, including a seat portion, a body portion, and a head portion, the seat portion and the head portion being horizontally connected to a same side of the body portion to straddle on the support rack, the seat portion being adapted for abutting against and being positioned on the support rack;
an pushing mechanism, including a driving portion and a pushing element, the driving portion being connected to the head portion, the pushing element being movably screwed with the driving portion, the pushing element being adapted for being driven by a driving tool to push the fourth end of the torsion arm to rotate away from the torsion adjusting assembly;
an insertion hole, formed on the head portion, the insertion hole being adapted for a handtool to insert in and engage with to make the main body and the handtool have a corotation relationship;
wherein when the driving tool rotates along a first direction to make the main body bear a force to have a first torque, the handtool exerts a force opposite to the first direction so that the main body have a second torque along a direction opposite to the first direction.

2. The dismantling tool of claim 1, wherein the insertion hole is formed with at least one positioning hole on an inner wall thereof, the at least one positioning hole is adapted for a positioning element of the handtool to engage.

3. The dismantling tool of claim 1, wherein the driving portion is formed with a threaded hole therethrough, the threaded hole has an axis parallel to an axis of the insertion hole.

4. The dismantling tool of claim 3, wherein the seat portion is protrudedly formed with an abutting portion for abutting against the support rack, the abutting portion and the threaded hole are co-axially arranged.

5. The dismantling tool of claim 3, wherein the axis of the threaded hole is defined as a standard line, a highest portion of the driving portion is located at a highest portion of the seat portion.

6. The dismantling tool of claim 3, wherein the axis of the threaded hole is defined as a standard line, the body portion extends from the head portion toward the seat portion to approach the standard line.

7. The dismantling tool of claim 1, wherein the head portion further includes a working face opposite to the seat portion, the insertion hole is formed on the working face, the driving portion includes a first end portion and a second end portion, the second end portion is located between the first end portion and the seat portion, the first end portion is protruded above the working face.

8. The dismantling tool of claim 7, wherein only the first end portion is protruded above the working face at an extension plane of the working face.

9. The dismantling tool of claim 1, wherein when observing along a direction facing an opening of the insertion hole, at least one of two lateral faces of the head portion has a protrusion adjacent to the insertion hole, the protrusion is protruded along a radial direction of the insertion hole.

10. The dismantling tool of claim 8, wherein the insertion hole is formed with at least one positioning hole on an inner wall thereof, the at least one positioning hole is adapted for a positioning element of the handtool to engage; the driving portion is formed with a threaded hole therethrough, the threaded hole has an axis parallel to an axis of the insertion hole; the seat portion is protrudedly formed with an abutting portion for abutting against the support rack, the abutting portion and the threaded hole are co-axially arranged; the axis of the threaded hole is defined as a standard line, a highest portion of the driving portion is located at a highest portion of the seat portion; the body portion extends from the head portion toward the seat portion to approach the standard line; when observing along a direction facing an opening of the insertion hole, at least one of two lateral faces of the head portion has a protrusion adjacent to the insertion hole, the protrusion is protruded along a radial direction of the insertion hole; the working face connects the two lateral faces horizontally; the main body is U-shaped; the dismantling tool further includes two wing portions, each of the wing portions is U-shaped, when observing along the direction facing the opening of the insertion hole, the two wing portions extend symmetrically and laterally from two sides of the main body so that the main body has a T-shaped cross-section; the threaded hole has a larger inner diameter than an inner diameter of the insertion hole; the pushing element includes an engaging portion, a threaded section, and a pushing portion, the engaging portion is adapted for the driving tool to engage, the threaded section is located between the engaging portion and the pushing portion, an end of the pushing portion remote from the engaging portion is tapered and pokes toward the seat portion; the torsion adjusting assembly includes a support seat and an adjusting bolt, the support seat is detachably disposed on the support rack through the support rack, the adjusting bolt is movably screwed with the support seat to abut against the fourth end of the torsion arm; each of the lateral faces has one said protrusion, the two protrusions are arranged symmetrically; the insertion hole has a polygonal cross-section, the insertion hole penetrates the head portion; a ratio of a distance between the axis of the threaded hole and the axis of the insertion hole to a distance between the two lateral faces is ranged 1.5-2.5; each of the protrusions is rectangle plate-shaped, the head portion has a hexagonal protruding portion, the insertion hole is formed on the hexagonal protruding portion, the hexagonal protruding portion connects to the two protrusions.
